(19) United States
(12) Patent Application Publication
(10) Pub. No.: US 2023/0242334 A1
(43) Pub. Date: Aug. 3, 2023

(54) CONTAINER FOR THE COLLECTION OF URBAN WASTE

(71) Applicant: Ocean Kube Environment, S.L., Pontevedra (ES)

(72) Inventor: José Antonio PENA PARGA, Moaña (Pontevedra) (ES)

(21) Appl. No.: 18/013,138

(22) PCT Filed: Jul. 5, 2021
(86) PCT No.: PCT/ES2021/070486

§ 371 Date: Dec. 27, 2022

(30) Foreign Application Priority Data
Jul. 8, 2020 (ES) U202031493

(51) Int. Cl. B65F 1/08; B65F 1/14; B65F 1/12

(52) U.S. Cl. CPC B65F 1/08; B65F 1/122; B65F 1/1473; B65F 2250/105; B65F 2250/111; B65F 2250/128

(57) ABSTRACT

Disclosed is a container for collecting urban waste, formed from an aluminium support structure that contains and protects a cardboard repository, which is characterised in that it comprises: a support structure comprising an external housing frame formed by a series of straight profiles and a flippable circular profile that forms the front access or entry of the container for the introduction of waste; a flippable circular plate or opening that closes the front access generated by the circular profile; a removable flippable cover that closes the frame assembly, the cover being able to flip open by means of gravity when the container is turned over; a bottom grate; and a cardboard repository contained in and supported by the housing frame, which is formed from cardboard sheets with flat folded faces.

### FIELD OF THE INVENTION

The present invention consists of a new type of container intended for the collection of urban waste, which has a particular structure that facilitates handling by operators and its operability in the collection of waste with trucks, in addition to having a structure that makes its manufacture to different sizes more flexible. Additionally, the invention consists of an assembly made of recyclable materials, which exhibits an environmental advantage when it comes to recycling and reusing the components of said container.

The field of application of the present invention is that which relates to different types of containers, preferably of the type located on the public road for the reception and collection of urban waste, these containers being able to be either static containers with legs or mobile containers with wheels.

### BACKGROUND OF THE INVENTION

It is well known that conventional collection containers are made of plastic, e.g. HDPE, which exhibit the advantage of eliminating odours by means of washing and are highly impermeable to liquid waste. However, as with any plastic element, this type of container exhibits problems when it comes to cleaning and maintenance. When it comes to cleaning the container, it becomes complex and costly to return to acceptable sanitary conditions, generally requiring chemical products and large quantities of water. Moreover, it is known that these containers break or degrade, both due to their use and to other fortuitous acts unrelated to the use of the container, which implies a high replacement cost and sometimes also environmental problems and, therefore, the known conventional containers have a high maintenance cost. The large number of mobile parts and mechanical parts make this maintenance a high cost for public entities, as they eventually fail and have to be replaced.

Taking into account this problem, there are known containers in which the structure, or a portion thereof, comprises recyclable storage elements, and which, after several uses, can be disposed of and exchanged for new ones, and specifically there are known solutions in which the container is made of cardboard. The inclusion of recyclable parts in a container exhibits advantages over conventional containers the structure of which is based solely on plastic materials. Among the different types of containers comprising recyclable materials, structures of different shapes stand out. For example, document EP260597 discloses a cardboard container having a cylindrical configuration; document ES2021254 discloses a cardboard container having a parallelepiped shape; or document EP2418156 wherein a container having a prismatic configuration is disclosed. Other types of containers are also known which, based on a structure of recyclable materials, exhibit improvements in terms of including different areas, storage areas or compartments within the container.

In any case, compared to plastic containers, containers in which the container is made of recyclable material, especially cardboard, exhibit the advantage that this material can be replaced whenever it is dirty, deteriorated or when a change of image is decided, which also saves on the use of tanker trucks to wash containers, water from the network, detergents or the purification of said dirt; a recyclable material is introduced that when removed from the container can be used to make a new cardboard, or if it has been soiled with organic waste it can be disposed of with the same waste for composting; and the printing of logos on the sides of the container is simplified and the possibility of high quality printing that is periodically replaceable is expanded, thus opening the possibility of having a new point of communication of ideas, adaptation to the environment, advertising or all kinds of campaigns of public or private entities.

These solutions based on recyclable material structures, especially cardboard, exhibit a problem of stability and strength. It must be taken into account that all containers are subjected to the user’s own manual handling forces, may be subjected to the forces of collection trucks that lift and shake them in the air, and are also subjected to the weight and movement of the same products that are stored in the container that hit against the container walls. Therefore, there is a problem regarding the stability of containers the structure of which is based on recyclable materials, especially cardboard containers.

At this point it is known that which is disclosed in document ES1214555U, which can be considered as the closest state of the art, which describes a type of container with a metal frame and a cardboard container, which improves the problems of stability and strength defined previously; however, this solution exhibits a rigid structure that is not versatile. Among the problems it presents is the fact that it does not allow to be stored, or that in case of breakage of one of its parts the whole frame must be replaced. As opposed to this solution, the present invention describes a container the structure of which is more versatile and allows different structures and/or frames to be stored, which is also a clear advantage when it comes to distribution throughout the city or area of interest, and exhibits a modular solution in which the different parts can be assembled and disassembled, which exhibits an advantage in maintenance. Additionally, the present invention features a container structure differentiated from this background.

In view of the problems related to containers for collecting waste, and of the solutions and background known in the state of the art, the present invention describes a container that exhibits improvements in terms of versatility and maintainability, while the assembly is stable and strong against the actions and stresses to which it is subjected both by operators and by the same waste, and which also incorporates a container that is entirely recyclable. Additionally, all current container models are restricted to only one type of collection, i.e., there are rear-loading models and side-loading models, whereas the present invention allows the same container model to serve for both types of unloading.

### DESCRIPTION OF THE INVENTION

The invention consists of a container for the collection of urban waste formed by two main parts, an aluminium support and housing structure, and a cardboard repository fitted into the support structure. Therefore, this container is made of reusable materials, which is an environmental advantage, and at the same time, all the elements thereof are removable, which is also an advantage for stacking and storage thereof.

The container of the present invention comprises:
an aluminium support structure, which is a frame that houses and protects a cardboard repository, and wherein the support structure comprises an external housing frame forming the eight edges of a cube; a supply opening located on the front face of the cube, arranged vertically, and with a plate that can only be flipped inwards; a cover able to flip open with respect to the cube which closes the frame assembly; and
a cardboard repository, which is housed and supported by the support structure; which is formed from four sheets of cardboard with flat folded faces, forming a regular parallelepiped open at the top portion, with a base and top portion of identical geometric shape; and wherein the base of the repository is located on a grate surface to facilitate the ventilation thereof.

Going into more detail, the flippable cover is preferably of circular cut with a system that only allows the inwards flipping thereof, so that it acts as an anti-theft system for the container. When the waste is deposited, there is no need for a pedal, as it is pushed with the same until the cover opens, and then the cover closes by means of gravity in a gentle or cushioned manner to the original position. This cover is attached to the housing structure, so that when the top cover is flipped, it remains in its position by means of a magnetic system; in this way, mobile parts are reduced during emptying, minimising noise.

At the rear portion of the structure, there is a comb for lifting the container for trucks or other mechanical means of collection within the rear loading category. The design also contemplates other collection systems, such as side loading, in which case instead of carrying the comb, it would carry two trunnions on the sides. Additionally, there are side-loading systems which use holes for hitching to the truck, commonly referred to as hitch sleeves; the design also provides for this possibility.

The emptying cover, which covers the entire top surface, has an opening system by means of gravity when the container is turned over, which prevents users from accessing the inside of the container. This system ensures that this door can only be opened when the truck performs the turn over. For noise reduction and to ensure the durability of the structure, the closure of this cover has a straightening system and rubber stops that prevent it from hitting violently against the cube.

Contact with the ground can be made by means of wheels, preferably made of aluminium and rubber, which allow the container to be easily moved. These four wheels are preferably located at the corners of the cube, and are attached to the housing structure. These wheels shall have a braking system or brakes to prevent slipping on slopes. Additionally, the invention comprises legs instead of wheels, for when there is no need to move the container, for example, in the case of side loading, the wheels are not required, while in the case of rear loading they are.

On the sides, the assembly has at least one handle or puller for convenient and safe manual handling of the container in all directions.

The cardboard repository consists of a set of flat folded faces that rests on the bottom grate and is covered by a top ring or protruding tabs, so that the edge thereof is protected against external agents. In addition, the top cover provides extra protection against the possible entry of liquids. In the opening area, the design is such that the hole is protected from the possible entry of liquid, and the magnetic fixing system prevents it from being opened accidentally by the action of the wind, for example.

The external front and side faces of the repository are visible, there are no obstructions to the structure, which allows the use thereof as an advertising, promotional or informative carrier, especially the front face, since it is that which provides the greatest exposure to users at the time of use. For this purpose, the cardboard walls of the repository comprise a printable surface.

It should be noted that, throughout the description and claims, the term “comprises” and its variants are not intended to exclude other technical features or additional elements. Considering this aspect, the present container for the collection of urban waste, is not limited to a size or shape of the deposit nor is limited to the previously indicated embodiment, but it allows to be variable in size and dimensions depending on the requirements of the population; in the same way, it is not limited to a single collection system, but it can be used for rear collection systems with comb, rear collection with trunnions, side collection with trunnions, side collection with sleeves or other similar ones existing on the market.

### BRIEF DESCRIPTION OF THE DRAWINGS

In order to complete the description and to help a better understanding of the features of the invention, a set of figures and drawings is presented wherein the following is represented by way of illustration and not limitation:

FIGS. 1A and 1B are free perspective, both rear and front, views of a container of the present invention, specifically in the rear loading mode, with wheels and comb.

FIGS. 2A and 2B are free perspective, both rear and front, views of the container, when the container is rotated and turned over, with the emptying cover open by means of gravity.

FIG. 3 shows an exploded view of the assembly and a perspective view of the components that form the container of the present invention.

FIG. 4 is a detail view of a cross-section where the cover is seen closed with respect to the housing frame of the container support structure and the manner in which the opening is flipped for a user to introduce waste inside the container.

FIG. 5 is a perspective exploded view of the different portions of the support structure of the invention.

FIG. 6 is an exemplary embodiment of the container in the universal version thereof, with comb, side-loading trunnions and sleeves.

FIG. 7 is a perspective view of the model according to the side-loading version thereof, without wheels and with larger dimensions for greater capacity, also prepared for a side-loading system by means of trunnions and sleeves.

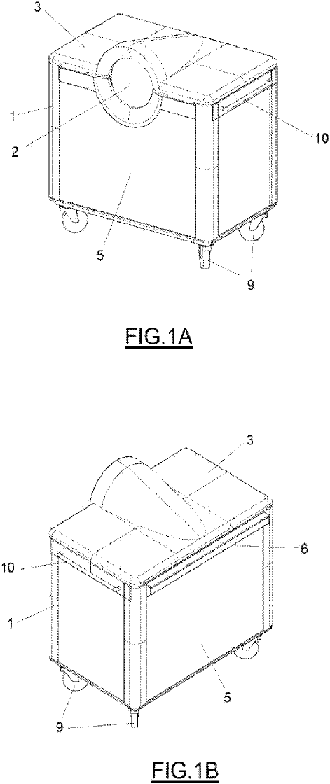

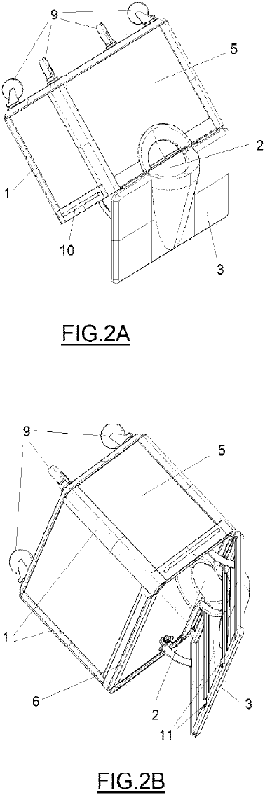

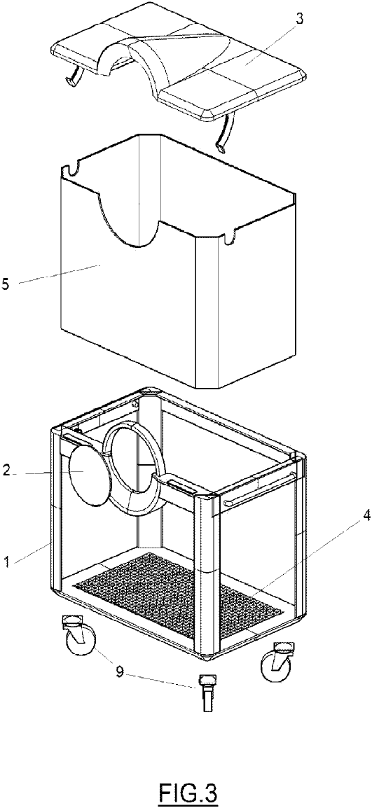

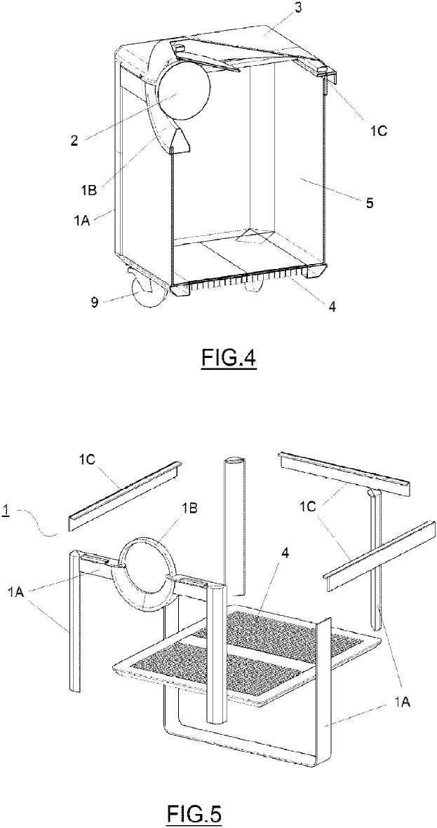

### DETAILED DESCRIPTION OF THE FIGURES OF THE INVENTION

It can be seen from the Figures that the invention consists of a container comprising a support and housing structure, and a cardboard repository fitted into the support structure. Although it cannot be seen in said figures, this container is formed entirely by reusable materials, both in the structure, where they are preferably made of aluminium, and in the repository, which is made of cardboard. One aspect that is represented in said figures is that all the elements thereof can be disassembled, which is an advantage for stacking and storage of the same.

As can be seen in said figures, the container comprises:
a support structure, which is a frame that houses and protects a repository (5), and wherein the support structure comprises:
   an external housing frame (1) formed by a series of straight profiles (1A) forming a cube and wherein a flippable circular profile (1B) is included that forms the entrance or front access of the container for the introduction of waste;
   a flippable circular plate or opening (2) vertically arranged that closes the front access by the user;
   a removable flippable cover (3) with respect to the frame (1) in the form of a cube and that closes the frame assembly; wherein the cover is able to flip open by means of gravity when the container is turned over; and has a straight flipping system with rubber stops (11) that prevent it from hitting violently against the frame; and which has a preferably magnetic anti-theft system for fixing to the frame (1) to remain closed in the rest position;
   a bottom grate (4), which is fixed to the bottom portion of the housing frame (1) and serves as a support for a cardboard repository;
a cardboard repository (5), which is housed and supported by the housing frame (1); which is formed from cardboard sheets with flat folded faces, forming a regular parallelepiped open at the top portion, with a base and top portion of identical geometric shape; and wherein the repository (5) rests on the grate (4) of the structure, and wherein the top portion of the repository is closed by straight closing profiles (1C) of the structure.

As can be seen in these figures, in a preferred embodiment of the invention, the opening (2) is circular in shape, although its shape and size can be suited to the typology of the fraction for which the container is intended. The opening has a support plate and a system for magnetic fixing with the frame, specifically with the circular profile (1B), which prevents the opening from opening accidentally or by the action of the wind, but it is the user who presses the opening with the waste and this is flipped inwards, returning to the initial position thereof once the waste has been deposited inside the container.

Moreover, as previously mentioned, the cardboard repository (5) consists of a set of flat folded faces that rests on the lower grate (4) and the top portion thereof is closed by a straight closing profile (1C) of the structure, this profile being a top ring or protruding tabs, such that the edge thereof of the repository (5) is protected against external agents.

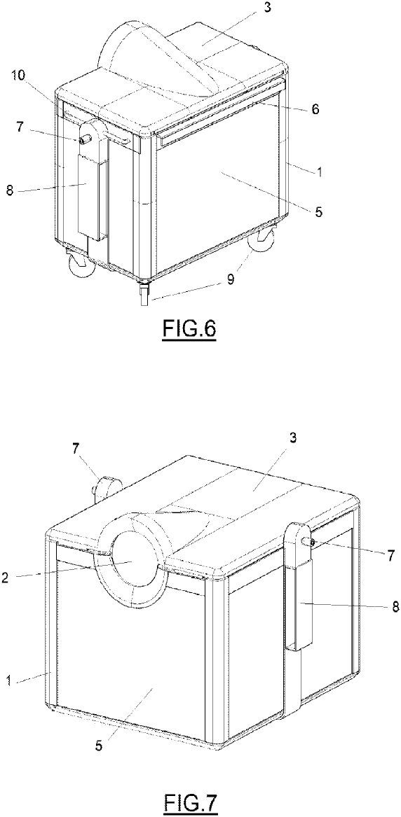

Among the various lifting means provided by the invention, it can be seen in said figures that on the rear wall of the housing frame there is a comb (6) for the rear lifting of the container for trucks or other mechanical means of collection. Furthermore, it can be seen from FIGS. 6 and 7 that the invention may further comprise protruding rear-loading trunnions (7) and/or protruding side-loading hitch sleeves (8) fixed to both sides of the housing frame, so as to allow the container to be lifted by means of a rear- or side-loading system.

Another aspect of the invention is that the user never has to touch the container with their hands, considering that a vertically flippable cover is currently used by means of a foot pedal. The need for a foot pedal is eliminated, simplifying the production, use and maintenance thereof, and there is no need to touch the cover with the hand, so the product does not serve as a source of contagion of diseases. Instead, the inwardly flippable opening, which has a magnetic fixing system with straightened or cushioned closing, simplifies the operation and substantially reduces the number of parts required, greatly reducing maintenance costs.

As can be seen in said figures, the contact of the container with the ground is carried out by means of wheels (9) with brakes that allow the easy movement of the container (in the case of rear loading) or legs in the case of side loading, wherein the wheels and/or legs are located in the bottom portion of the housing frame. The wheels can be made of aluminium and rubber as they allow for easy movement of the container. The legs may comprise a non-slip surface. At least one handle or puller (10) can be provided on the sides of the frame for convenient and safe handling of the container in all directions.

Another particularity of the invention is that the invention allows the repository to be used for advertising, promotional or informational purposes. The repository (5) is formed from a cardboard sheet that is folded such that any type of advertising, promotional or informative message can be reproduced on the external faces of said cardboard. In this regard, the external faces of the repository (5) are visible since there are no obstructions of the structure, in particular the front and rear faces, and may comprise a surface that is printable.

1. A container for the collection of urban waste, formed from an aluminium support structure that contains and protects a cardboard repository, characterised in that it comprises:
a support structure comprising:
an external housing frame (1) formed by a series of straight profiles (1A) and a flippable circular profile (1B) that forms the entry or front access of the container for the introduction of waste;
a flippable circular plate or opening (2) vertically arranged that closes the front access generated by the circular profile (1B);
a removable flippable cover (3) with respect to the frame (1) that closes the frame assembly; wherein the cover is able to flip open by means of gravity when the container is turned over;
a bottom grate (4), which is fixed to the lower portion of the housing frame (1) and supports a cardboard repository; and
a cardboard repository (5), which is housed and supported by the housing frame (1); which is formed from cardboard sheets with flat folded faces, forming a regular parallelepiped open at the top portion, with a base and top portion of identical geometric shape; and wherein the repository (5) rests on the grate (4) of the structure, and wherein the top portion of the repository is closed by straight closing profiles (1C) of the structure.

2. The container for the collection of urban waste, according to claim 1, wherein the cover (3) comprises a straight flipping system with stops (11).

3. The container for the collection of urban waste, according to claim 2, wherein the stops (11) are made of rubber.

4. The container for the collection of urban waste, according to claim 1, wherein the opening (2) has a supporting plate and a system for magnetic fixing with the frame.

5. The container for the collection of urban waste, according to claim 1, characterised in that on the rear wall of the housing frame there is a comb (6) for the rear elevation of the container.

6. The container for the collection of urban waste, according to claim 1, characterised in that it comprises protruding rear-loading trunnions (7) fixed to both sides of the housing frame.

7. The container for the collection of urban waste, according to claim 1, characterised in that it comprises protruding side-loading hitch sleeves (8) fixed to both sides of the housing frame.

8. The container for the collection of urban waste, according to claim 1, characterised in that it comprises wheels (9) located in the lower portion of the housing frame.

9. The container for the collection of urban waste, according to claim 8, wherein the wheels have brakes.

10. The container for the collection of urban waste, according to claim 1, characterised in that it comprises legs located in the lower portion of the housing frame.

11. The container for the collection of urban waste, according to claim 10, wherein the legs comprise a non-slip surface.

12. The container for the collection of urban waste, according to claim 1, characterised in that at least one handle or puller (10) is provided on the sides of the frame.

13. The container for the collection of urban waste, according to claim 1, wherein the external faces of the cardboard repository (5) comprise a printable surface.
